(19) United States
(12) Patent Application Publication
(10) Pub. No.: US 2010/0194780 A1
(43) Pub. Date: Aug. 5, 2010

(54) METHOD AND APPARATUS FOR MAKING A MOSAIC

(76) Inventor: Edward Acworth, Boston, MA (US)

Correspondence Address: BROWN RUDNICK LLP, ONE FINANCIAL CENTER, BOSTON, MA, 02111, US

(21) Appl. No.: 12/671,093

(22) PCT Filed: Aug. 8, 2008
(86) PCT No.: PCT/US08/72615

§ 371 Date: Jan. 28, 2010

Related U.S. Application Data
(60) Provisional application No. 60/956,836, filed on Aug. 20, 2007.
(60) Provisional application No. 61/026,826, filed on Feb. 7, 2008.

(51) Int. Cl. G09G 5/00; G06T 11/20

(52) U.S. Cl. 345/619; 345/441

(57) ABSTRACT

A method and a system for building a mosaic. The system includes a software processor to design a pattern from an image, a graphical user interface, an operational manager, a sorter, an inspection station, a bufferer and a mechanical mechanism. The pattern is disassembled into a plurality of sub-images, each of the plurality of sub-images is associated with at least one tile. The operational manager determines materials, a quantity of materials and a location in the pattern for each of the at least one tile. The sorter sorts the at least one tile and the inspection station conducts a quality control review for each of the at least one tile. The bufferer buffers each of the at least one tile according to a command from the operational manager and the mechanical mechanism picks and places each of the at least one tile in a predetermined position, as determined by the software processor.

### CROSS-REFERENCE TO RELATED APPLICATIONS

This patent application claims priority to U.S. Provisional Application Ser. No. 60/956,836, filed in the U.S. Patent and Trademark Office on Aug. 20, 2007 by Edward Acworth, and U.S. Provisional Application Ser. No. 61/026,826, filed in the U.S. Patent and Trademark Office on Feb. 7, 2008 by Edward Acworth, the entire contents of these applications being incorporated herein by reference in its entirety.

### BACKGROUND

1. Technical Field

The present disclosure relates to creating a mosaic. In particular, the present disclosure is directed to creating a mosaic by arranging a plurality of tiles based on a design and calculated and implemented by software and a machine.

2. Description of the Related Art

The art of creating mosaics has existed for millennia, all over the world. A mosaic is essentially a decorative surface made by inlaying pieces of variously colored material or tiles, to form pictures and/or patterns. In the art, it is generally known that the pieces of material used to form mosaics are ceramic, marble, stone and other types of tiles. The pieces of material are normally held in place by mortar, glue, grout, or other adhesives.

Known methods for creating mosaics include best match methods, where attributes are matched to a target region or subregion. That particular method requires significant human labor and it is extremely time consuming. Other methods known in the art lack quality control measures. Therefore, there is a need for a method and system of creating a mosaic efficiently, cost effectively and with little error.

### SUMMARY

In an embodiment of the present disclosure, a system for building a mosaic is presented. The system includes a software processor to design a pattern from an image, a graphical user interface, an operational manager, a sorter, an inspection station, a bufferer and a mechanical mechanism. The pattern is disassembled into a plurality of sub-images, each of the plurality of sub-images is associated with at least one tile. The operational manager determines materials, a quantity of materials and a location in the pattern for each of the at least one tile. The sorter sorts the at least one tile and the inspection station conducts a quality control review for each of the at least one tile. The bufferer buffers each of the at least one tile according to a command from the operational manager and the mechanical mechanism picks and places each of the at least one tile in a predetermined position, as determined by the software processor.

In another embodiment of the present disclosure, a method for forming a mosaic is presented. The method includes the steps of disassembling an image into a plurality of pixels and inputting feedback relating to the image and the disassembly of the image. Each of the plurality of pixels is associated with at least one tile. The method also includes determining materials, a quantity of a plurality of tiles and a location for each of the plurality of tiles. The method further includes sorting the plurality of tiles, inspecting the plurality of tiles to determine a color for each of the plurality of tiles and to conduct a quality control review for each of the plurality of tiles, and buffering each of the plurality of tiles according to its color, as determined by the step of inspecting. Further, the method includes picking and placing each of the plurality of tiles in a position and assembling the selected tiles into a mosaic, the mosaic being substantially similar to the image.

In yet another embodiment of the present disclosure, a method for forming a mosaic is presented. The method includes inputting an image, adjusting the image using a graphical user interface and processing the image into a pattern by disassembling the image into a plurality of pixels, each of the plurality of pixels is assigned a color. The method also includes determining a quantity of a plurality of tiles and a location in the pattern for each of the plurality of tiles, sorting the plurality of tiles into a single feed mechanism, and inspecting the plurality of tiles to conduct a quality control review for each of the plurality of tiles. Further, the method includes assigning a color to each of the plurality of tiles, buffering each of the plurality of tiles according to its color, picking and placing each of the plurality of tiles in a predetermined position, and assembling the selected tiles into a mosaic, the mosaic being substantially similar to the image.

In another embodiment of the present disclosure, a system for building a mosaic is presented. The system includes a graphical user interface to input feedback regarding an image and to manipulate the image, a processor to disassemble the image into a plurality of pixels, each of the plurality of pixels is associated with a color and an operational manager to determine a type of material, a quantity of tiles and a location for each of the tiles. The system further includes a sorter to sort each of the tiles, an inspection station to determine a color for each of the tiles and to conduct a quality control review for each of the tiles, a buffer to group each of the tiles according to the color assigned to each of the tiles at the inspection station, and a robotic arm to pick and place each of the tiles in a predetermined position, as determined by the processor.

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings as set forth below:

FIG. 1 is a flow diagram illustrating a hardware element of the method used to form a mosaic according to an embodiment of the present disclosure;

FIG. 2 is a flow diagram illustrating a software element of the method used to form a mosaic according to an embodiment of the present disclosure;

FIG. 3 is a block diagram illustrating a system used to create a mosaic;

FIG. 4 is an illustrative example of an intersection of two “sections” using a floating surface technique according to an embodiment of the present disclosure;

FIG. 5 is an example illustrating an interlocking capability of a “section” using a floating surface technique of the present disclosure;

FIG. 6 is an illustrative example of a section used in a mosaic, according to an embodiment of the present disclosure; and

FIG. 7 is an illustrative example of a mosaic created, according to an embodiment of the present invention.

### DETAILED DESCRIPTION OF EXEMPLARY EMBODIMENTS

The following detailed description refers to the accompanying drawings. The same reference numbers in different drawings may identify the same or similar elements. In addition, the following detailed description does not limit the present disclosure.

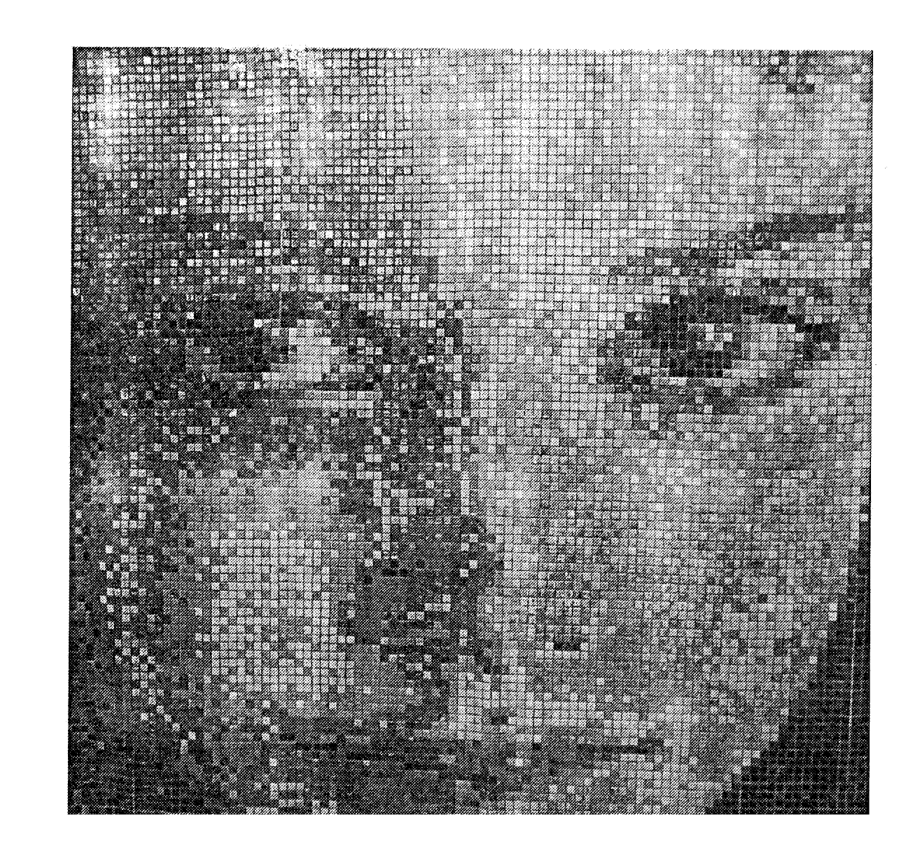

The present disclosure includes a method and a system for creating a mosaic. Even though the present disclosure is described as using tiles, the disclosure is not limited to the use of tiles to create the mosaic, as the use of tiles is for exemplary and explanatory purposes. A mosaic, an example of which is shown in FIG. 7, may be created using any type of, but not limited to, two-dimensional or three-dimensional object. The two or three-dimensional object may comprise of any material, any substance, any shape, any size, and/or any composition, such as, for example, but not limited to, leather, wood, food, candy, etc.

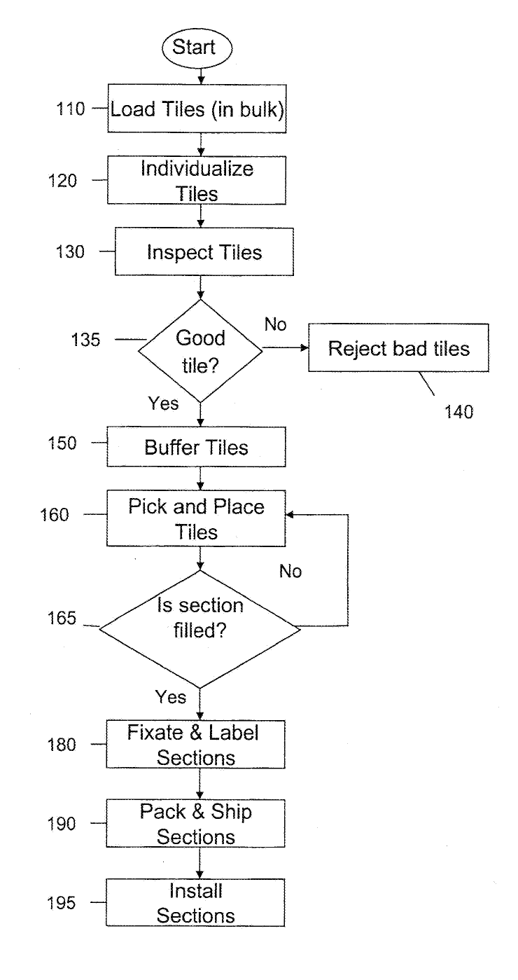

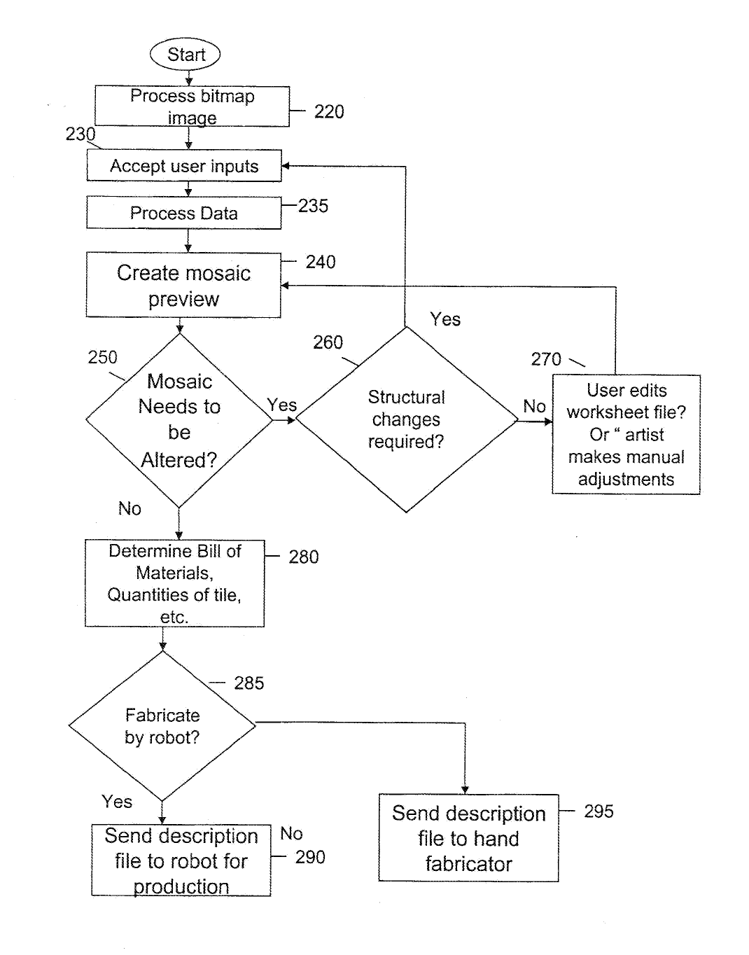

A method of the present disclosure includes a hardware implementation and a software implementation, as illustrated in FIGS. 1 and 2, respectively. The hardware and software may work together or may work alone and are described as follows.

The design for the mosaic may be based on a pre-existing image. For example, a mosaic may be a replica of a specific bitmap photograph. On the other hand, the mosaic may be a replica of an image created by an artist specifically for the mosaic. Referring to FIG. 2, at step 220, an image that is to be replicated in the mosaic is uploaded and is broken down into pixels, where one or more pixels are to be associated with a tile. At step 230, a user may add structural input to the image. Structural inputs may include tile size and palette, size of grout line width, project size, and matching algorithm. Further, the user enters his/her input on a graphical user interface. The graphical user interface may have a tile palette building function which offers users material and/or color matching capabilities, for example. Palette colors may be adjusted manually or by a software. In addition, the software may import and/or export palette sets and identify colors from photographs. The software may allow the creation of printed photorealistic samples.

At step 235, the user input and the image are processed according to an algorithm used to create a mosaic. Once the user has completed his/her inputs at step 230 and the image is processed at step 235, a digital preview of the mosaic is created as a bitmap image, at step 240. A software algorithm uses the source bitmap image and the user inputs to calculate how the pixels are associated with tiles. For example, each pixel is a specific color, and therefore a tile of that specific color is associated with that pixel, which is essentially a specific position in the image design or in the mosaic. The preview appears on the graphical user interface for the user to review.

At step 250, the user decides whether or not the image should be altered. If the user determines that structural changes should be made, at step 260, then the software flow goes back to step 230, where the user may input a variety of changes that are to be made. If structural changes need not be made, at step 270, the user may make manual adjustments to the mosaic by simply editing a worksheet file, and/or the user may make manual adjustments to the image, and then a new image of the mosaic preview will be output for the user to review (step 240). Examples of a structural change include changes to the project dimensions, tile size, grout width, tile palette, dither, etc. (e.g. resize project, change tile size, etc. other program parameters). Examples of manual adjustments include manually changing tile colors tile by tile, using brush tools to paint new tile colors across a broader swath, using a gradient tool to blend tile colors, etc.

If the image of the mosaic preview, at step 250, does not require any alterations, then the operational manager, at step 280, determines the quantity and types of materials that are required to create the mosaic. Generally, an independent source, either a human or a machine, reviews the materials inventory to insure that the tile is available for the project. A further task of the operational manager is to keep track of the inventory and to make sure that there is enough of each type of tile required in the mosaic, as determined in step 280. If there is not enough of something, in one embodiment, the materials will be ordered and available for the creation of the mosaic. In another embodiment, the process will return to step 230, where the user may input changes to the design, in order to incorporate the materials that are stocked in the inventory, or to exclude certain materials. Once the materials and quantities are confirmed, at step 285, a determination is to be made whether or not the mosaic will be fabricated by a robot. If the mosaic will be fabricated by a robot, then the worksheet file will be sent to the robot for production, at step 290. If the mosaic will not be fabricated by a robot, then the file will be sent to a hand fabricator, at step 295.

Turning now to FIG. 1, the hardware implementation of the method of the present disclosure is presented. The system may include a vacuum system, a pressurized air system, various power supplies, a structural frame, a PC and/or machine control system, optics, a camera, a vision recognition system, a robotic placement system, a tile buffer system, and other systems. The system may also include Bulk tile sorting, tile lanes, tile inspection, tile presentation to the robot, placement of tile in desired pattern, fixation or support sheet application and finished section labeling.

At step 110, tiles used for the creation of a mosaic are loaded into a machine in bulk. The tiles are then individualized, at step 120, as they are lined up, individually, from a mass of tiles loaded in at step 110.

At step 130, the tiles are inspected for quality control, where it is determined, at step 135, whether the tiles are accepted or rejected. For example, a tile that has a geometric defect such as a tile that is chipped or broken will be rejected, at step 140. Another example of a tile that could be rejected is a tile that is off-color. If a tile is considered good, then it continues on to the next step. The inspection, at step 130, may include a vision system. The vision system determines the delivery of a good tile versus the delivery of a faulty tile. Further, along with being able to determine the color of a tile, the vision system may also be able to match colors of tiles, to inspect geometric shapes of tiles and to match them or use them accordingly. In addition, the color is analyzed and determined at this stage. Further, the tile surface color pattern may be characterized more fully, for use by the software matching algorithm to achieve a better fit in the mosaic. For example, striations in natural stone such as marble may be characterized.

At step 150, the tiles are buffered and organized into groups of tiles with the same color. The tile buffer may take the form of, but is not limited to, a lane conveyor, gravity feed lanes, in-line feeders, cartridges, turret loaded cartridges, hopper, tape reel, or any other form. An escapement mechanism at the end of each buffer holds the tile for picking by the robot. Once the tiles are buffered in groups by color, at step 160, the tiles are picked from the appropriate buffer location and placed into the appropriate position in its respective section. The tiles may be picked up and placed manually and/or by using a robot. The position and section in which to place the tile is determined by the operational manager where the operational manager can either be software or a human. The pick and place system may comprise of a robotic arm assembly system, wherein the robotic arm picks up a correct tile and places it according to a delegation. Another pick and place system includes a rolling element, placing tiles robotically. Another system includes an articulated arm that delivers tiles back and forth. Yes another system includes a Cartesian robot that delivers tiles, and another system includes a rastering trajectory that delivers tiles back and forth.

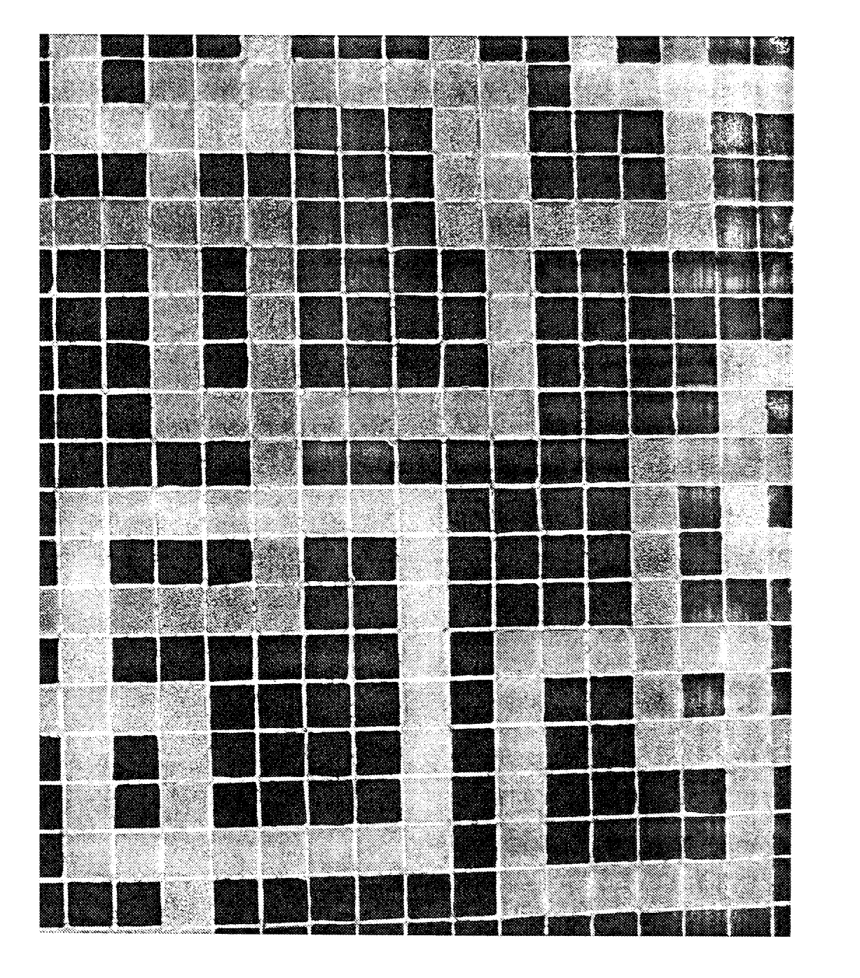

In an embodiment of the present disclosure, the software program will delegate both an arrangement of the tiles into appropriate sections, and the sections into a final piece of art or into a mosaic. Thus, the placements of the tiles in the entire project may be determined using the software program. At step 165, a determination is made as to whether the particular section being populated is filled. If it is not filled, then the process goes back to step 160. If it is filled, then the process continues. An example of a section can be found in FIG. 6.

In an embodiment, the robotic assembly has the capability to pick and place a plurality of tiles of a commanded color and to a commanded position, using the x, the y, the z and the yaw positioning. The present invention has tile placement precision, where it uses the x-axis, y-axis, z-axis, and theta-z axis to correctly and accurately place each tile. A raster head may also be implemented, where a feed mechanism is used to rapidly feed out each tile, one by one to the feed head depositing tiles.

A vacuum system may be applied to prepare a workplace for fixing the tiles into a section. Once the sections are fixated and labeled at step 180, the vacuum may be removed. Or, in another embodiment, a structural grid may be used to hold the placed tiles. Or, in another embodiment, tiles may be placed directly onto the final fixation (such as clear polymer tape) without being held temporarily in an intermediate support structure.

Moving along to step 190, the sections are packed and shipped to an end user. Further, at step 195, each section is installed together, usually in a specified order, to form the mosaic.

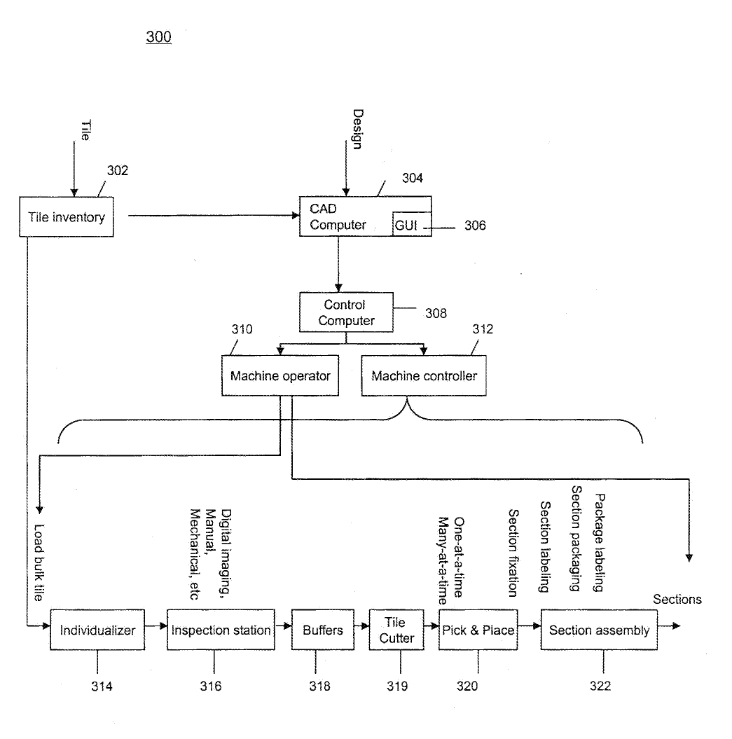

FIG. 3 illustrates a block diagram of an embodiment of a system of the present disclosure. The system 300 includes a bulk quantity of tiles 302 that eventually go through a sorting and buffering process, as previously discussed.

A CAD computer 304, including a graphical user interface (GUI) 306, allows a user to either design a pattern to be created by a mosaic, and/or allows a user to input an existing image into the CAD computer 304 and further allows the user to edit the image to his/her specifications and requirements, using the GUI 306. A software algorithm creates a mosaic from an input image and user inputs.

Once the design has been finalized, the design is sent to the computer controller 308. The computer controller 308 manages the production system, which will be used to create the end result, a mosaic. The system further includes a human machine operator 310 and a machine controller 312, which together operate the machine.

The machine operator 310 is a human being, who physically loads the bulk tiles from the tile inventory 302 and also is responsible for making sure the sections are removed appropriately from the machine, packaged and shipped out to the appropriate end user. The machine controller 312 operates the machine hardware subsystems, and is essentially the controller of an individualizer 314, an inspection station 316, buffers 318, a pick and place mechanism 320 and a section assembly process 322. Another embodiment may have a tile cutter component 319, where individual tiles are selected from the buffers, and machine cut before being picked and placed, according to the design.

Once the tile inventory 302 is loaded by the machine operator 310, each tile is separated and lined up by the individualizer 314. Further, each tile is subject to quality control at the inspection station 316. The quality control may be implemented by digital imaging review, a manual visual review, and/or a mechanical review whereby each tile is sent through a machine with feelers on either end, or a scale, to determine if the tile is whole, or any other inspection means.

After the tiles have been inspected, they are sent to the buffer 318. The buffer will store the tiles according to their color or other characteristic. After the tiles are sent through the buffer 318, individual tiles may be selected from the buffers 318 and may be sent to a machine cutter 319, where tiles are shaped and cut, before being picked and placed, according to a design. The pick and place mechanism 320 literally picks each of the tiles from the buffer or the machine cutter 319, that is required for the mosaic, and places each of the tiles into a designated position in a section. The pick and place mechanism 320 may pick and place the tiles one by one, or may pick and place a plurality at a time using a variety of the previously mentioned methods. The section assembler 322 receives each of the tiles that have been placed into each of the sections and fixes the tiles to the section, labels the section, packages the section and labels the package. Then, the sections are shipped to the end user.

Tiles may be placed together and may form a section in a variety of ways, according to the present disclosure. In an embodiment, a thin polymer film is placed behind the square section of tiles. The polymer film is adhesive on at least one side, whereby allowing the tiles to form a section. Other embodiments may use a mesh backing, and/or adhesive bond between tiles, or other fixation methods.

In another embodiment of the present disclosure, the tiles adhere to one another with a glue like substance on at least one of the four sides of a tile, whereby the tiles may stick to one another. In yet another embodiment of the present disclosure, at least one tile adheres to at least one other tile using an adhesive netting on the back of the tiles, or a glue dispensing onto fiberglass mesh, on the backs of the tiles.

Tiles will generally be affixed to a surface, such as, but not limited to, a floor or a wall. In another embodiment of the present disclosure, tiles may be affixed to one another. In yet another embodiment of the present disclosure, a flexible or rigid adhesive may be used to adhere the tiles together in an edge to edge configuration. In another embodiment, tiles may be affixed to a material backing to the tiles, such as a mesh, paper or a polymer film. In yet another embodiment, tiles may be affixed to a material fronting on the top of the tiles, like a mesh, paper or a polymer film. Further, tiles may be affixed to a material backing to the tiles, like a rigid structural substrate.

Tiles used in a mosaic created by the method and system of the present invention do not necessarily have to be of the same type and dimension. Tiles may usually be square rectangular or octagonal, but may be any geometry, or a variety of geometries. Tiles may be a prefabricated geometry, or the system may shape each individual tile in accordance with the mosaic design. A machine in accordance with the present disclosure may use similar tiles for a project, or may vary the tiles used. In addition, tiles may be received in bags of loose tile, including defective tiles, good tiles and contaminants. The good tiles may be automatically sorted out using the method and system of the present disclosure.

The software of the present disclosure may also include a pricing function that bases prices from materials, time, functions, labor, etc. The software includes the capability to estimate various features of the process of the project, for example, but not limited to, the time, material types and quantities, number of sections and more.

In addition, the software has the capability to interface with three-dimensional complex surface modeling, project three-dimensional imaging from an input, and decompose a three-dimensional function for wrapping sheets of tiles around a three-dimensional object. The software may use as an input as-built metrologies of actual complex surfaces that are to be covered with mosaic.

A tile, as used in connection with the present disclosure, may be a solo tile made from any material, including but not limited to, glass, stone, porcelain, ceramic, metal, wood, leather, mixed materials, food products, ice and others. A tile may also be opaque, translucent or transparent, depending on the use of the tile. Generally, tiles are arranged in a specified order to form a section. In one embodiment, a section is a square, rectangle, polygon, circle, oval, diamond or other planar geometric shape comprising a plurality of tiles. In another embodiment, a section is one square foot comprising a plurality of tiles. A section may be one square foot or any other size. The section is used with a plurality of other sections to be placed together to form an art work, mosaic or a project. In an embodiment, a project is an entire picture or design made from a plurality of sections.

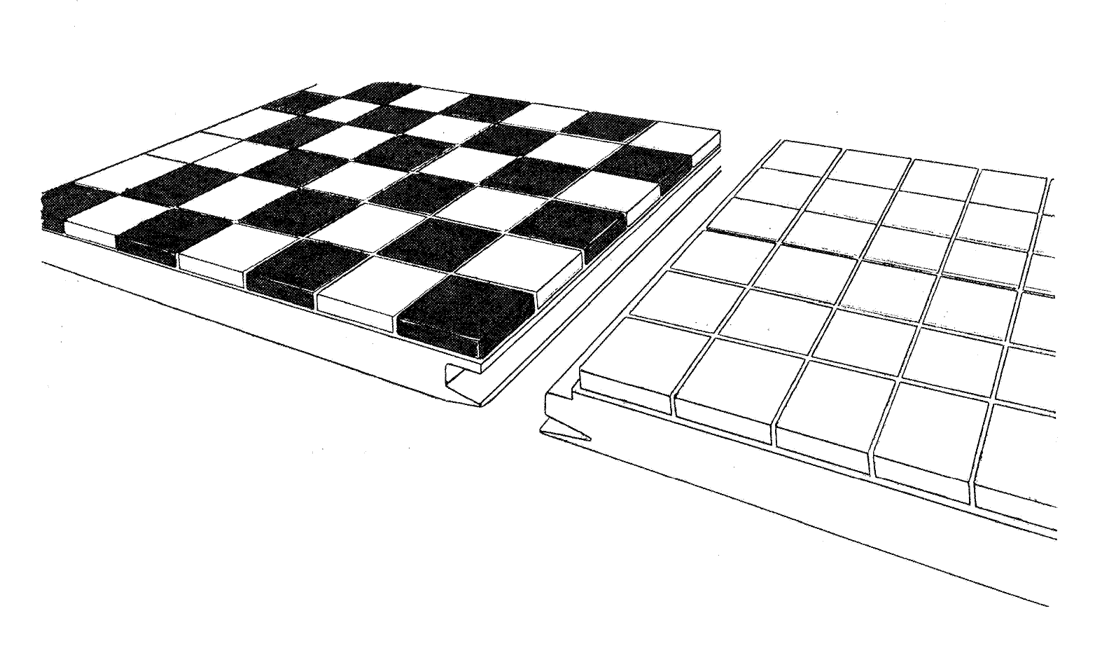

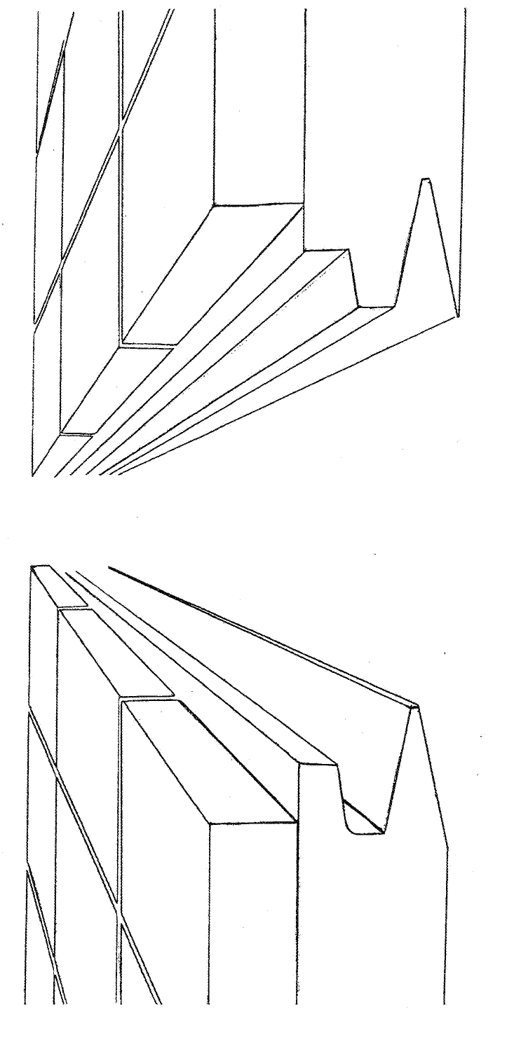

In a further embodiment, the system of the present disclosure includes a floating surface mosaic system. This system may combine a layer of any assembly of tiles, including mosaic, onto a substrate of interlocking sections (see FIGS. 4 and 5, wherein FIG. 5 is a close up of the interlocking section), to form a floating surface substrate system. The substrates allow for the physical support, interlocking and fast efficient installation of the surface finishing system. A finishing surface material is affixed atop the substrates, which is a material that may be visible after the installation. The system may be used for flooring, or on any other surface, including but not limited to walls, ceilings and others.

In using the floating floor system of the present disclosure, installation labor and time is greatly reduced because entire sections of tiling may be installed rapidly in each substrate section, as shown in FIGS. 4 and 5. Each substrate section may be any shape or geometry, including rectangular and also may be any size. In some embodiments, each section may be 12 by 12 inches, or 15.5 by 15.5 inches, for example. In an embodiment, each section may be completely finished, in that all of the tiles are grouted and assembly is complete. Installation is greatly expedited because all that is required is the installation of each section, and grout is only applied between each section rather than between each tile.

Another embodiment of the present disclosure includes a backlist mosaic, including a combination of a layer of any assembly of tile, including mosaic, onto a substrate of luminescent light emitting material, or any light box design including, but is not limited to, Light Emitting Diodes, incandescent, halogen, the sun, or any other light source, where the light passes through and/or between the tiles such that a viewer may see the tiles and/or grout as illuminated from within. Transparent, translucent, non-translucent or opaque tiles may be used solely or in combination to achieve an artistic or any other effect. Transparent, translucent, non-translucent or opaque grout between tiles may also be used solely or in combination to achieve an artistic or other effect. Thus, the surface that is covered with mosaic may be seen by the viewer to glow or emit light.

A light source behind a mosaic or within a mosaic may be solid as one color, or it may be a combination of multiple light sources, to allow addressability of the light sources. Electricity, power and/or control signals and/or sensor signals may be routed through or within each section and may interconnect between sections. In one embodiment, a standard section interconnect may be an integral part of each section.

In addition, a backlit mosaic may or may not be further enhanced by combining it with a floating surface mosaic system to make a modular floating section with a substrate, an illumination and a tile mosaic in an assembly.

In another embodiment of the present disclosure, a robot is used with a technology that is implemented to manufacture a mosaic using tiles of any shape required for the mosaic final product. This particular embodiment allows for the manufacture of a mosaic using individual tiles of inconsistent geometries to fit each tile position. In another embodiment, the tiles are each pre-cut to a specified shape before placing into the mosaic. Mixed tile sizes may also be used in a project, for example, but not limited to, 1″ tiles and ½″ tiles used in one project. Also, there may be backlighting of translucent colored glass mosaic sheets, for example, a 1/16″ thick ElectroLuminescent sheet or any other light source. In addition, light emitting tiles are implemented. Light emitting tiles may have light source elements within.

Mosaics made with the method and/or system of the present disclosure may cover any non-planar surface (curved convex/concave), including deconvoluted complex surfaces and projections. Flexible material grout and tiles may also be used in order to create a flexible mosaic sheet. In addition, mosaics may be covered with flexible fabrics, in order to make pillows and clothing, for example. This may be made by attaching solid or flexible tiles to a flexible fabric substrate.

Another embodiment of the present disclosure incorporates the ability to design and make mosaic rugs, which in one embodiment are movable and flexible rugs made of tile.

In yet another embodiment, impressionist mosaics may be implemented. These are unlike traditional mosaics which often rely on homogeneously colored tile material. Contrarily, impressionist mosaics use natural flaws and marbling in some types of tile materials (marbles, glasses, etc.) to create the impression of an image. Vision and software may assist in the characterization and determination of placement. In one embodiment, a plurality of tiles, such as 10, 100 or 1000 tiles may be placed together on a storage/buffer surface imaged together to create a catalog of characterized tiles for later fitting into the mosaic. In another embodiment, tiles may be characterized sequentially and then stored/buffered for later use. Storage/buffering may be gravity or spring loaded feed chute or magazine or cartridge, or may be a conveyor belt, or other method.

No element, act, or instruction used in the present disclosure should be construed as critical or essential unless explicitly described as such. In addition, as used herein, the article “a” is intended to include one or more items. Where only one item is intended, the term “one” or similar language is used.

It will be understood that various modifications may be made to the embodiments disclosed herein. Therefore, the above description should not be construed as limiting, but merely as exemplifications of the various embodiments of the present disclosure. Those skilled in the art will envision other modifications within the scope and spirit of the claims appended hereto.

What is claimed is:

1. A system for building a mosaic, the system comprising:
a software processor to design a pattern from an image, the pattern is disassembled into a plurality of sub-images, each of the plurality of sub-images is associated with at least one tile;
a graphical user interface;
an operational manager to determine materials, a quantity of materials and a location in the pattern for each of the at least one tile;
a sorter to sort the at least one tile;
an inspection station to conduct a quality control review for each of the at least one tile;
a bufferer to buffer each of the at least one tile according to a command from the operational manager; and
a mechanical mechanism to pick and place each of the at least one tile in a predetermined position, as determined by the software processor.

2. The system of claim 1, wherein the mechanical mechanism is a robot.

3. The system of claim 1, wherein the inspection station includes a person visually inspecting the at least one tile.

4. The system of claim 1, wherein the inspection station includes a computer vision system that automatically inspects that at least one tile.

5. The system of claim 1, wherein a color is assigned to each of the at least one tile.

6. The system of claim 1, wherein a surface characterization is assigned to each of the at least one tile.

7. The system of claim 1, wherein the operational manager is a software program.

8. The system of claim 1, wherein the operational manager is a person.

9. The system of claim 1, wherein the image is input by a user on the graphical user interface.

10. The system of claim 1, wherein a user may alter the image using the graphical user interface.

11. The system of claim 1, wherein at least a portion of the mosaic is not opaque.

12. A mosaic formed by the method comprising the steps of:
disassembling an image into a plurality of pixels, wherein each of the plurality of pixels is associated with at least one tile;
inputting feedback relating to the image and the disassembly of the image;
determining materials, a quantity of a plurality of tiles and a location for each of the plurality of tiles;
sorting the plurality of tiles;
inspecting the plurality of tiles to determine a color for each of the plurality of tiles and to conduct a quality control review for each of the plurality of tiles;
buffering each of the plurality of tiles according to its color, as determined by the step of inspecting;
picking and placing each of the plurality of tiles in a position; and
assembling the selected tiles into a mosaic, the mosaic being substantially similar to the image.

13. The mosaic formed by the method of claim 12, further comprising the step of:
adhering each of the plurality of tiles to one another.

14. The mosaic formed by the method of claim 12, wherein the plurality of tiles are affixed to a backing material.

15. The mosaic formed by the method of claim 12, wherein the plurality of tiles are affixed to a fronting material.

16. The mosaic formed by the method of claim 12, wherein a robot is used for the step of picking and placing.

17. The method of claim 12, wherein the inspecting step comprises a person visually inspecting each of the plurality of tiles for quality control and/or assigning a color and/or a characterization to each of the plurality of tiles.

18. The method of claim 12, wherein the feedback is input on a graphical user interface by a user.

19. The method of claim 12, wherein at least a portion of the plurality of tiles are not opaque.

20. A mosaic formed by the method comprising the steps of:
inputting an image;
adjusting the image using a graphical user interface;
processing the image into a pattern by disassembling the image into a plurality of pixels, each of the plurality of pixels is assigned a color;
determining a quantity of a plurality of tiles and a location in the pattern for each of the plurality of tiles;
sorting the plurality of tiles into a single feed mechanism;
inspecting the plurality of tiles to conduct a quality control review for each of the plurality of tiles;
assigning a color to each of the plurality of tiles;
buffering each of the plurality of tiles according to its color;
picking and placing each of the plurality of tiles in a predetermined position; and
assembling the selected tiles into a mosaic, the mosaic being substantially similar to the image.

21. The mosaic formed by the method of claim 20, wherein at least a portion of the plurality of tiles is not opaque.

22. A system for building a mosaic, the system comprising:
a graphical user interface to input feedback regarding an image and to manipulate the image;
a processor to disassemble the image into a plurality of pixels, each of the plurality of pixels is associated with a color;
an operational manager to determine a type of material, a quantity of tiles and a location for each of the tiles;
a sorter to sort each of the tiles;
an inspection station to determine a color for each of the tiles and to conduct a quality control review for each of the tiles;
a buffer to group each of the tiles according to the color assigned to each of the tiles at the inspection station; and
a robotic arm to pick and place each of the tiles in a predetermined position, as determined by the processor.

23. The system of claim 22, wherein at least a portion of the each of the tiles is not opaque.
